(19) United States
(12) Patent Application Publication
(10) Pub. No.: US 2009/0249845 A1
(43) Pub. Date: Oct. 8, 2009

(54) AUTOMOBILE GEARSHIFT LEVER LOCK ASSEMBLY

(76) Inventor: Ping-Hua Wu, Kaohsiung (TW)

Correspondence Address: LEONG C LEI, PMB # 1008, 1867 YGNACIO VALLEY ROAD, WALNUT CREEK, CA, 94598, US

(21) Appl. No.: 12/061,669

(22) Filed: Apr. 3, 2008

(51) Int. Cl. E05B 65/12

(52) U.S. Cl. 70/247

(57) ABSTRACT

An automobile gearshift lever lock includes an outer decorative cover, a latch, a lock, a coupling element, and a steel mounting plate. The lock includes a core and a securing mechanism. The lock is housed, around an outer circumference thereof, by a lock shell. The coupling element forms an open channel. The lock shell is fit into the open channel of the coupling element and fit over the lock to form a unitary device, which can be mounted to the mounting plate by various means. Opposite sides of the lock are protected by protection members. The core is provided, on a front surface thereof, with a protective face plate. As such, the mechanical strength of the lock is enhanced and the lock can be protected against any damage to thereby reduce the chance of automobile burglary.

### BACKGROUND OF THE INVENTION

(a) Technical Field of the Invention

The present invention relates to an automobile gearshift lever lock, and in particular to an automobile gearshift lever lock that comprises protective members to protect the lock from being damaged.

(b) Description of the Prior Art

A conventional gearshift lever lock comprises a mounting plate arranged by an enclosure of an automobile transmission box and a lock is bolted to the mounting plate. The lock forms two symmetric locking holes into which two legs of a U-shaped latch extend to be positioned at front and rear sides of the gearshift lever. The two legs thus restrain the displacement of the gearshift lever, thereby making it impossible to effect gear shifting for protecting the automobile from burglary. Such a conventional gearshift lever lock is arranged beside the enclosure of the transmission box, namely the lock is exposed, and it thus is not of visual aesthetics. Also the exposure and protrusion of the lock interferes with the movement of automobile seat and passengers. Thus, concealed automobile gearshift lever lock assembly is available in the market, which is illustrated in FIGS. 1 and 2 and designated at 1, wherein a steel mounting plate 11 is fixed inside the enclosure 2 of an automobile transmission box and the lock 1 has a body 12 that is enclosed at an outer circumference thereof by a heat-treated shell 13 and a plastic case 14, and is fixed to the mounting plate 11. In other words, the mounting plate 11 and the lock 1 are arranged inside the enclosure 2 with an end face of the lock 1 substantially flush with a side wall of the enclosure 2. A protective frame 21 is then fit around a circumference of the end face of the lock 1. A latch 15 extends through a latch bore 131 into the interior of the enclosure 2 for locking and positioning to impose a constraint in the enclosure 2. With the mounting plate 11 and the lock 1 both arranged inside the enclosure 2, the interior aesthetics of the automobile can be maintained. However, since the lock 1 as a whole is bulky and since there is only very limited space inside the enclosure 2, theoretically, the end face of the shell 13 can be made flush with the side wall of the transmission box enclosure 2, yet in reality, due the bulkiness of the lock 1, the end face of the lock 1 projects beyond the side wall of the transmission box enclosure 2 and the protective frame 21 by quite a distance. Again, interference with the movement of automobile chair and passengers occur. Further, since different models of vehicle manufactured by different manufacturers are provided with different configurations and interior spaces of transmission box enclosures. Thus, although automobiles of some models or brads may have sufficient interior space inside the transmission box enclosure to accommodate the mounting plate 11 and the lock 1, yet others do not have sufficient interior space for the mounting plate 11 and the lock 1, especially for the economic small-sized cars. Further, since the lock 1 is fixed to the mounting plate 11 by bolts 16, once an upper portion of the transmission box enclosure 2 is broken, burglars can access ad thus release the bolts 16 to detach the lock 1 from the mounting plate 11, making the lock losing its function of locking.

To prevent the above mentioned gearshift lever lock from being damaged and thus losing functionality, a concealed gearshift lever lock, which is designated at 3, shown in FIG. 3 is available in the market. The gearshift lever lock 3 has essentially the same construction as that described previously. In other words, a steel mounting plate 31 fixes a lock 3 that has a body 32 that is housed, around an outer circumference thereof, by a heat-treated shell 33 and a plastic case 34, and a latch 35 extends through a latch bore 321 for locking and positioning. The fixing of the lock 3 to the mounting plate 31 is realized by means of threaded engagement provided by bolts 36 and is also secured by a pin 37 that is inserted into the lock 3 in such a way that the pin 37 cannot be removed once inserted. With the arrangement of the pin 37, even the transmission box enclosure is broken to expose the mounting plate 31 and the lock 3 and release the bolts 36, the lock 3 cannot be removed from the mounting plate 31 due to the pin 37. Thus, since the latch 35 maintains in the locking condition, the gearshift lever is still kept from moving, thereby ensuring protection against burglary. However, again, this known lock as a whole is still bulky and may not be fit for automobiles of all models and brands. It also surfers the problem of lock projecting beyond the side wall of the transmission box enclosure.

Thus, it is desired to have a concealed gearshift lever lock that is applicable to automobiles of all models and brands, while ensure protection against burglary.

### SUMMARY OF THE INVENTION

The primary purpose of the present invention is to provide an automobile gearshift lever lock, comprising an outer decorative cover, a latch, a lock, a coupling element, and a steel mounting plate. The lock comprises a core and a securing mechanism. The lock is housed, around an outer circumference thereof, by a lock shell. The coupling element forms an open channel. The lock shell is fit into the open channel of the coupling element and fit over the lock to form a unitary device, which can be mounted to the mounting plate by various means. Opposite sides of the lock are protected by protection members. The core is provided, on a front surface thereof, with a protective face plate. As such, the mechanical strength of the lock is enhanced and the lock can be protected against any damage to thereby reduce the chance of automobile burglary.

Another objective of the present invention is to provide an automobile gearshift lever lock, comprising an outer decorative cover, a latch, a lock, a coupling element, and a steel mounting plate. The lock comprises a core and a securing mechanism. The lock is housed, around an outer circumference thereof, by a lock shell. The coupling element forms an open channel. The lock shell is fit into the open channel of the coupling element and fit over the lock to form a unitary device, which can be mounted to the mounting plate by various means. The securing mechanism comprises a switching plate, which forms a slot for receiving the insertion of a key for rotation of the switching plate. With the rotation of the switching plate driven by the key, a pin that is coupled to the switch plate drives a securing plate to disengage from a locking slot defined in the latch, thereby allowing the latch to be removed out of the lock for unlocking the gearshift lever lock.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view illustrating a conventional automobile gearshift lever lock mounted in an enclosure of an automobile transmission box;

FIG. 2 is an exploded view of the conventional automobile gearshift lever lock;

FIG. 3 is an exploded view of another conventional automobile gearshift lever lock;

FIG. 4 is an exploded view of an automobile gearshift lever lock assembly constructed in accordance with the present invention;

FIG. 5 is a perspective view illustrating a first example of fixing the gearshift lever lock of the present invention to a mounting plate;

FIG. 6 is a perspective view illustrating a second example of fixing the gearshift lever lock of the present invention to a mounting plate;

FIG. 7 is a perspective view illustrating a third example of fixing the gearshift lever lock of the present invention to a mounting plate;

FIG. 8 is a schematic view illustrating a locking operation of the automobile gearshift lever lock assembly of the present invention; and

FIG. 9 is a schematic view illustrating an unlocking operation of the automobile gearshift lever lock assembly of the present invention.

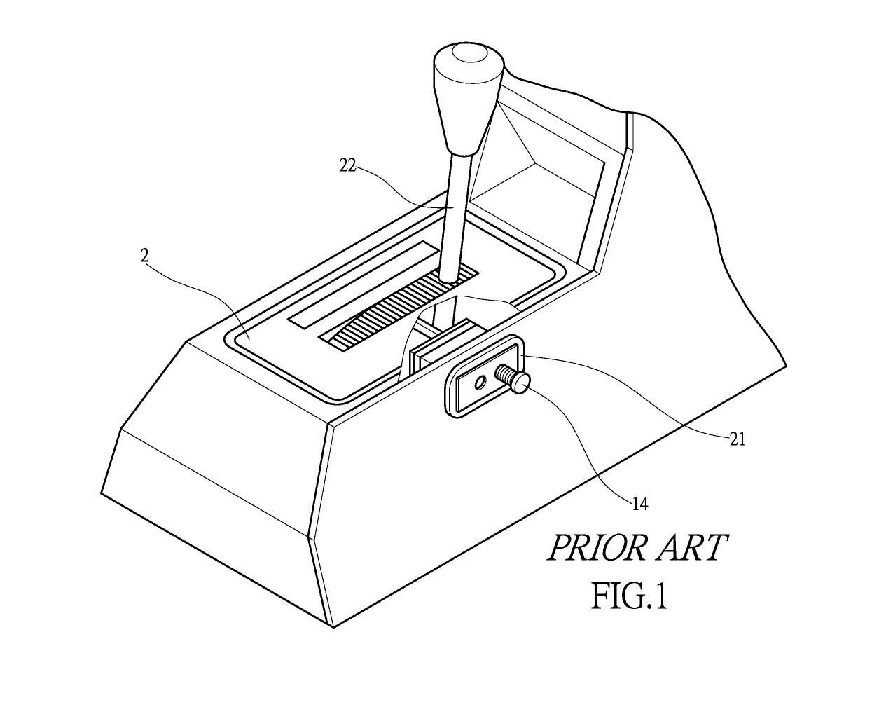

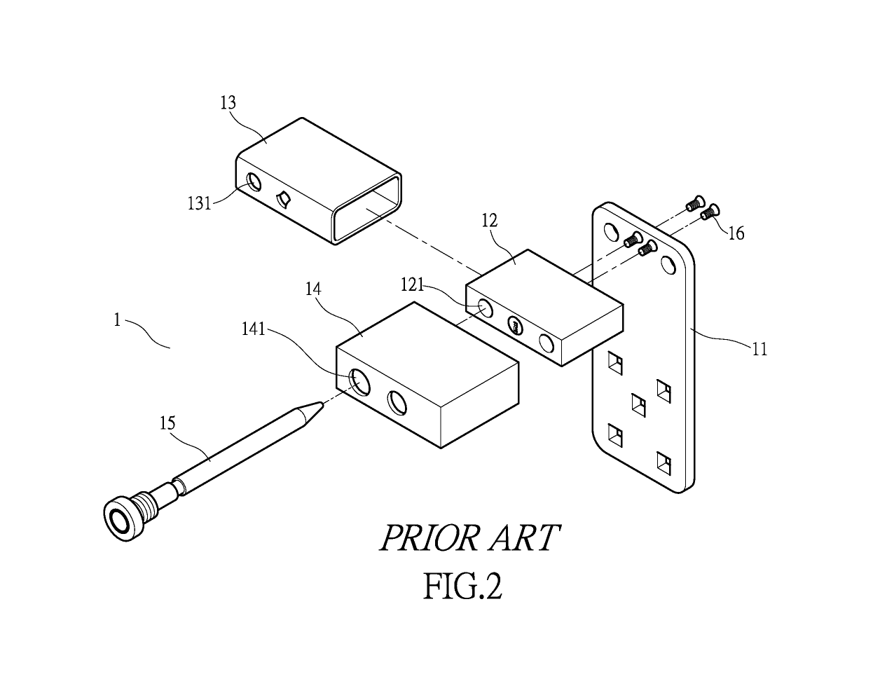

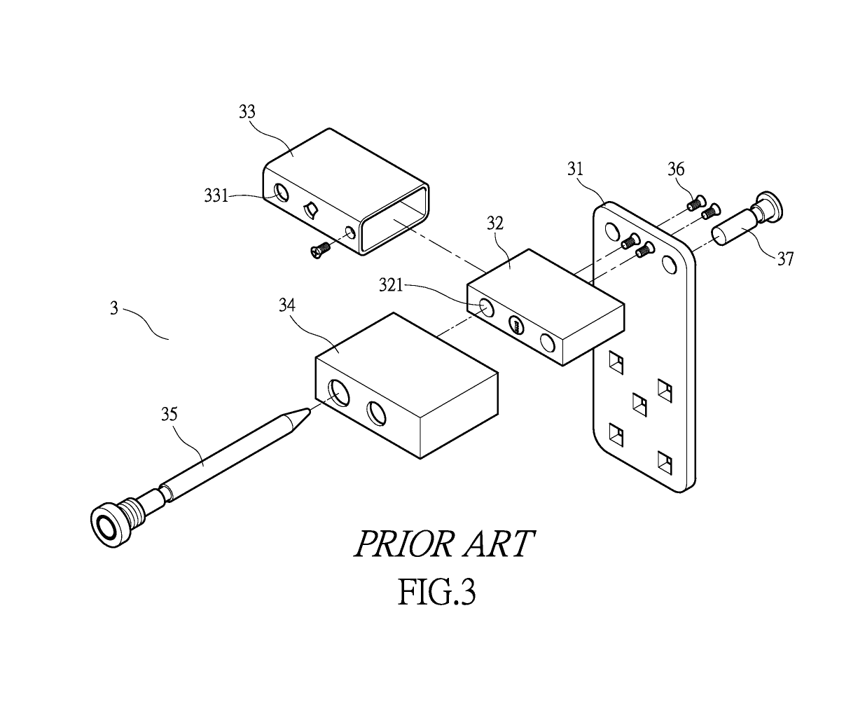

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

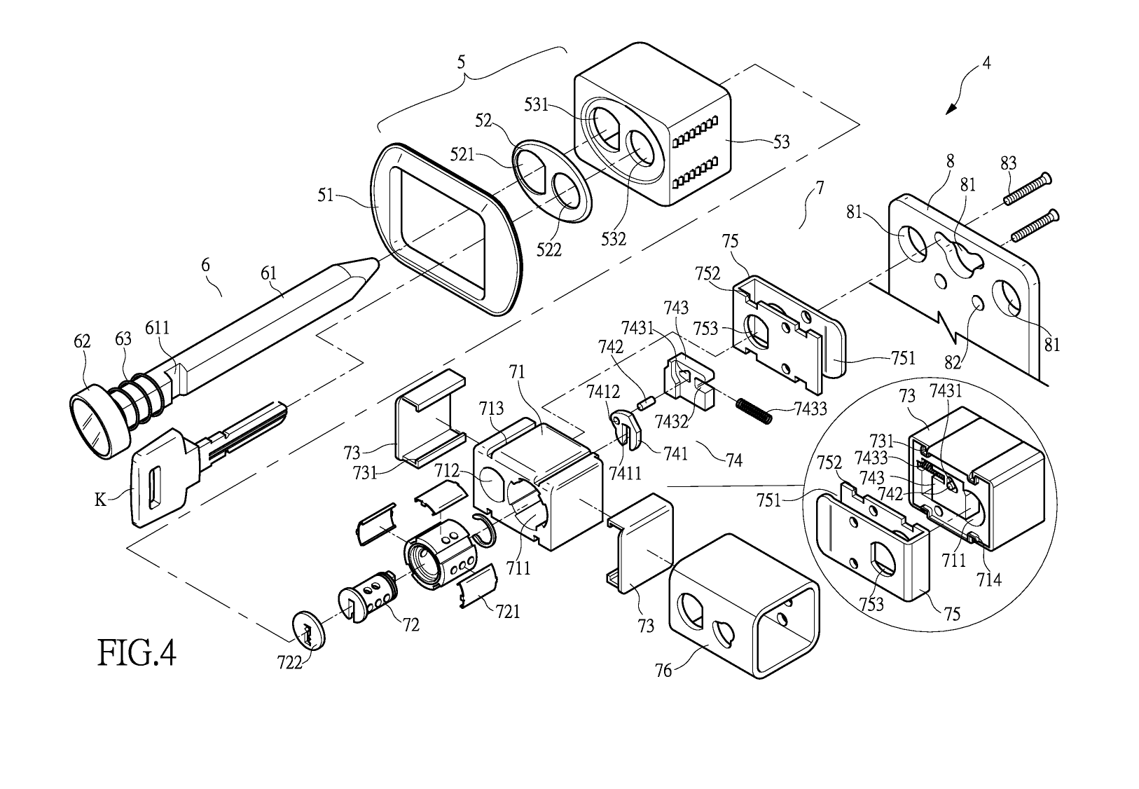

With reference to the drawings and in particular to FIG. 4, an automobile gearshift lever lock assembly constructed in accordance with the present invention, generally designated at 4, comprises an outer decorative cover 5, a latch 6, a lock 7, and a mounting plate 8, which is preferably made of steel.

The outer cover 5 comprises a decorative frame 51, a face plate 52, and a case 53. The frame 51 is mounted to an outside surface of an enclosure of an automobile transmission box (not shown). The face plate 52 forms a latch bore 521 and a key hole 522. The case 53 similarly forms a latch bore 531 and a key hole 532. The face plate 52 is mounted to a surface of the case 53, while the case 53 is arranged inside the transmission box enclosure. The latch 6 comprises a latch bar 61 made of a tough material, such as metal, and a grip 62. A spring 63 encompasses the latch 6 in proximity of the grip 62. The latch bar 61 forms a locking slot 611.

The lock 7 comprises a body 71, a core 72, two protection members 73, a securing mechanism 74, a coupling element 75, and a lock shell 76. The body 71 forms a core bore 711 and a latch bore 712. The core 72 is received in the core bore 711 of the body 71. A plurality of protective pads 721, which is subjected to for example heat treatment, is arranged outside the core 72. The core 72 is also provided with a protective face plate 722 that is attached to a surface thereof and is subjected to for example heat treatment. The protective pads 721 and the protective face plate 722 protect the core from being damaged. The body 71 has upper and lower surfaces in which positioning grooves 713 that correspond in position to each other are defined. The protection members 73 are made of tough and properly treated material, such as what has been heat treated to possess high hardness. Upper and lower edges of each protection member 73 forms fitting sections 731. The securing mechanism 74 is arranged rearward of the body 71 and the securing mechanism 74 comprises a switching plate 741, a pin 742, and a securing plate 743. The switching plate 741 forms a slot 7411 and a positioning hole 7412. The slot 741 functions to receive the insertion of a key K, while the positioning hole 7412 serves to receive and position the pin 742. The securing plate 743 forms a pin hole 7431, which is a through hole of a substantially triangular shape. The securing plate 743 also forms, in a side edge thereof, a notch 7432, in which a resilient element 7433 is received. The pin hole 7431 serves to partially receive and engage the pin 742 therein. When the key K is inserted into the slot 7411 of the switching plate 741 for rotating the switching plate 741, the pin 742 drives, through engagement thereof with the triangular pin hole 7431 of the securing plate 743, a transverse displacement of the securing plate 743. The body 71 has a rear surface that is recessed and that has upper and lower edges along which a plurality of raised positioning devices 714 are formed for fitting engagement with the coupling element 75. The coupling element 75 comprises a U-shaped plate comprised of opposite first and second boards delimiting an open channel 751 therebetween. The surface area of the first board of the coupling element 75 is substantially corresponding to the recessed area of the rear surface of the body 71 and upper and lower edges of the first board of the coupling element 75 forms notches 752 corresponding to and fit to the positioning devices 714 of the body 71. With the fitting engagement of the notches 752 with the positioning devices 714, the coupling element 75 is mounted to the body 71. The boards of the coupling element 75 form aligned latch bores 753. The lock shell 76 is received into the open channel 751 of the coupling element 75 and fit over the body 71 in a transverse direction to secure the board of the coupling element 75 that forms the notches 752 between the rear surface of the body 71 and a side wall of the lock shell 76. With the fitting engagement between the positioning devices 714 and the notches 752, the coupling element 75 cannot be detached from the lock 7, whereby the body 71 and the coupling element 75 are secured together.

The mounting plate 8, which is preferably made of steel, is mounted inside the enclosure of the automobile transmission box. The mounting plate 8 has an upper portion forming a through hole 81 for the extension of the latch 6. The mounting plate 8 also forms bolt receiving holes 82 for the extension of bolts 83 to fasten to the coupling element 75.

To assemble the lock 7, the core 72 that is covered by the protective pads 721 is put into the core bore 711 of the body 71 and the protective face plate 722 is mounted to the front of the core 72. The fitting sections 731 of the protection members 73 are fit into the positioning grooves 713 of the body 71. And, the securing mechanism 74 is positioned on the rear surface of the body 71. Thereafter, the coupling element 75 is fit to the recessed area of the rear surface of the body 71 with the notches 752 of the coupling element 75 engaging the positioning devices 714 of the body 71 for positioning. Finally, the lock shell 76 is fit into the open channel 751 of the coupling element 75 and fit over the body 71 in the transverse direction to complete the assembling of the lock 7.

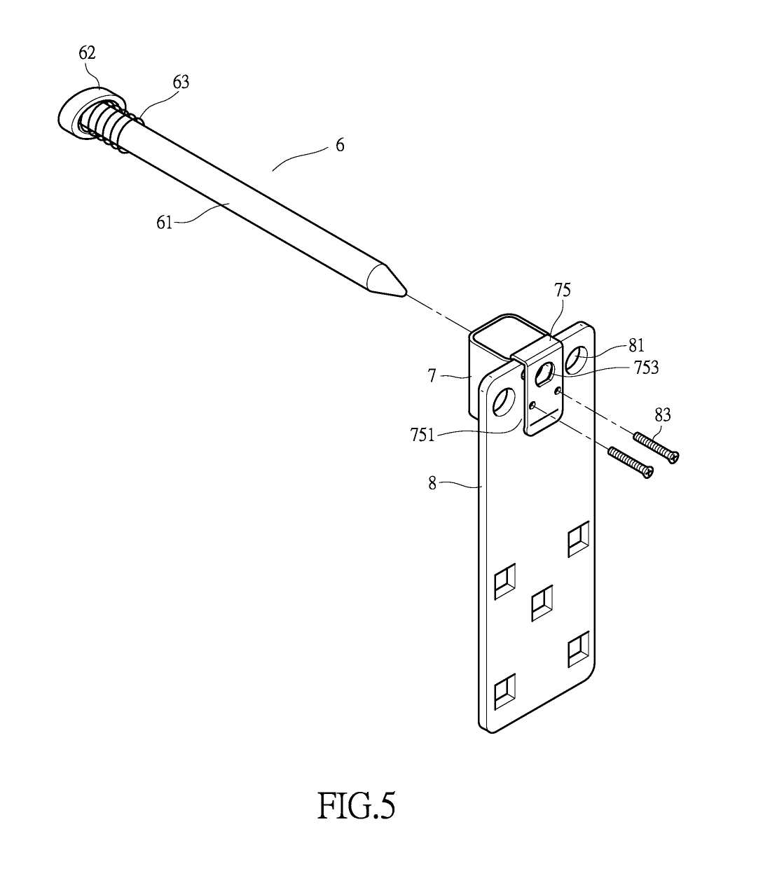

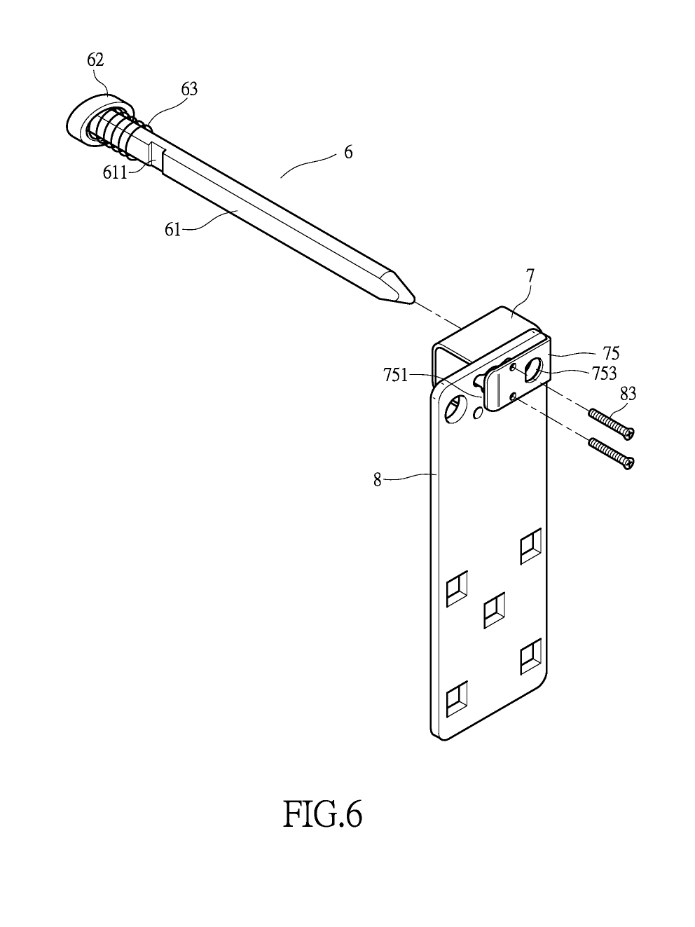

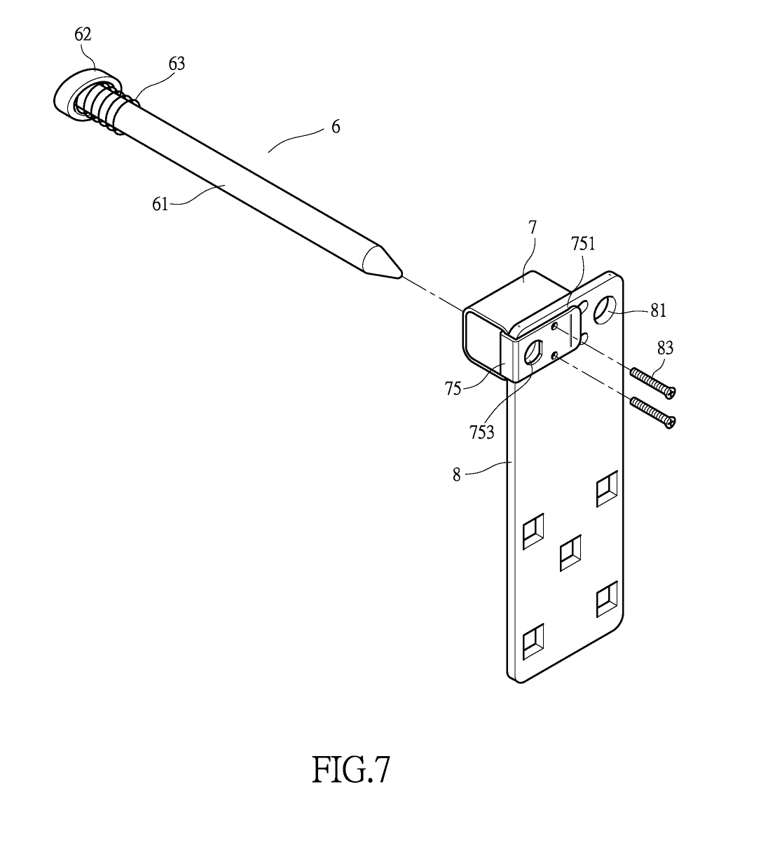

Also referring to FIG. 5, to mount the lock 7 to the mounting plate 8, the open channel 751 of the coupling element 75 is fit over a central portion of an upper edge of the mounting plate 8 and they are then fixed together with screws 83 to effect the mounting. Or alternatively, as shown in FIG. 6, the open channel 751 of the coupling element 75 is fit over a lateral side edge of an upper portion of the mounting plate 8 and then screws 83 are used to fix them together. Or, as shown in FIG. 7, the open channel 751 of the coupling element 75 is fit over an opposite lateral side edge of the upper portion of the mounting plate 8 and then screws 83 are used to fix them together. All these illustrative ways allow the lock 7 to be secured to the mounting plate 8 as a unitary device. Then, the case 53 of the outer cover 5 is fit over and houses the lock 7 of the lock assembly 4 and the decorative frame 51 is positioned on the outside surface of the enclosure of the automobile transmission box to represent an integral and complete commercial product.

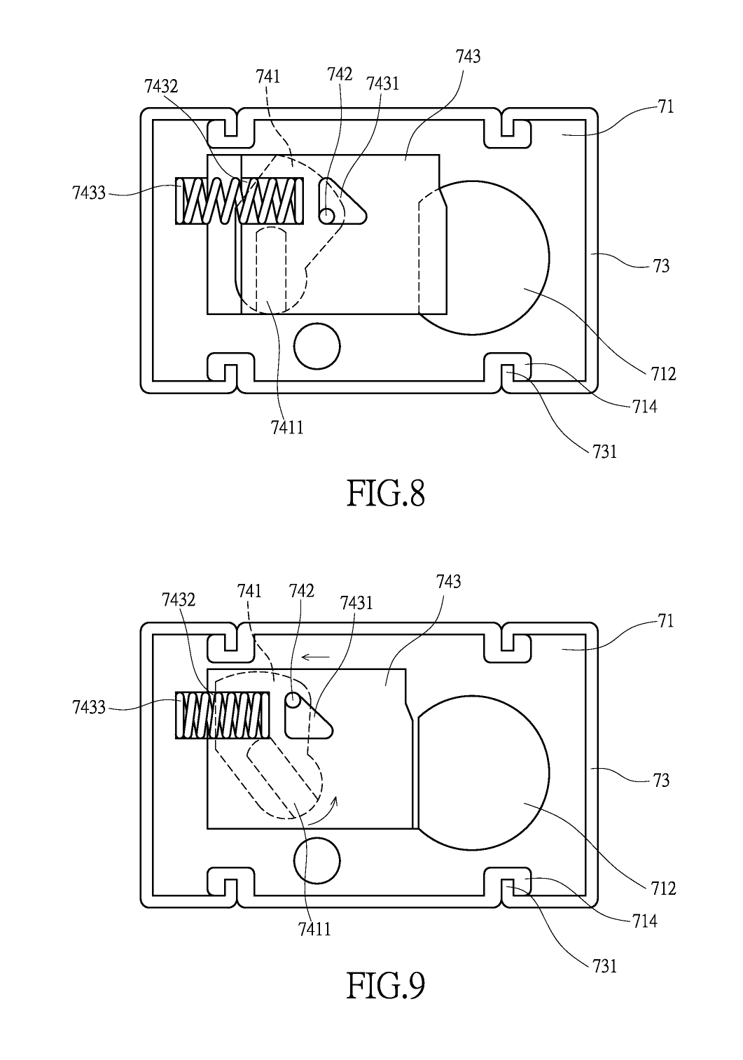

Also referring to FIGS. 8 and 9, to practice the present invention for securing the automobile gearshift lever with the lock assembly 4, the latch 6 extends from outside the automobile transmission box enclosure through the latch bore 712 of the body 71 and the latch bore 753 of the coupling element 75 to project beyond the mounting plate 8 through the hole 81 thereof and the latch 6 is thus positioned behind and abuts against the gearshift lever. At this time, due to the biasing provided by the resilient element 7433 of the securing plate 743 of the securing mechanism 74 is moved to engage the locking slot 611 of the latch 6. To release the constraint so imposed to the latch 6, the key K is inserted into the core 72 and rotating the key K causes the rotation of the switching plate 741 of the securing mechanism 74, and the pin 742 received in the switching plate 741 drives the securing plate 743 to disengage from the locking slot 611 of the latch 6, whereby the latch 6, under the springing action of the spring 63, is biased outward and the locking slot 611 is released from the constraint imposed by the securing plate 743. Thus, the latch 6 is allowed to withdrawn out of the lock 7 to effect unlocking of the lock assembly 4.

The advantage of the present invention is that the lock 7 and the mounting plate 8 are fixed together by the coupling element 5, rather then employing screws and a fixing pin as are found in the conventional arrangements. In such a coupling arrangement of the present invention, the size of the lock 7 can be remarkably reduced. This not only saves the manufacturing costs, but also prevents an end portion of the lock 7 from projecting beyond the side wall of the transmission box enclosure, because the size of the lock 7 is reduced. Thus, movement of automobile seat and passengers are not interfered with by the gearshift lever lock. Further, with the size reduction of the lock assembly 4, various arrangements for the combination of the sized-reduced lock assembly 4 and the mounting plate 8 can be effected. Therefore, the present invention is applicable to vehicles of various brands and models and is not subjected to any limitation due to the limited interior space inside the transmission box enclosure, all these widening the application of the present invention and enhancing convenience of assembling. In addition, the body 71 of the lock 7 is protected by the two protection members 73, which are members subjected to heat treatment, arranged on opposite sides of the body 71 and is also housed in the lock shell 76, which can be also heat-treated, so that the core 72 of the lock 7 is protected from being damaged by burglary that breaks through the sides of the body 71 by drilling to access the core 72 encased in the body 71. The front surface of the core 72 is similarly protected by a protective face plate 722 that is also subjected to heat treatment, so that direct access and damage of the core 72 from the front surface thereof is prevented. In this way, the lock 7 is securely protected against physical damage and locking is ensured and secured.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An automobile gearshift lever lock assembly comprising:
an outer cover;
a latch comprising a metal latch bar and a grip, the lath bar forming a locking slot;
a lock housed in the outer cover and comprising a body forming a latch bore and a core bore, a securing mechanism being arranged rearward of the body, the body being encased in a lock shell, a coupling element fit to the lock shell; and
a mounting plate having an upper portion forming a through hole for the extension of the latch and also forming bolt receiving holes;
wherein the mounting plate is adapted to fix inside an enclosure of an automobile transmission box and the coupling element to which the lock is attached is fit over the mounting plate to secure together and wherein the latch is insertable from outside the enclosure of the automobile transmission box into the lock to retrain movement of a gearshift lever of the automobile transmission box.

2. The automobile gearshift lever lock assembly as claimed in claim 1, wherein the outer cover comprises a decorative frame, a face plate and a case.

3. The automobile gearshift lever lock assembly as claimed in claim 1, wherein the latch is provided with a spring encompassing the latch body in the proximity of the grip.

4. The automobile gearshift lever lock assembly as claimed in claim 1, wherein the core is covered by heat-treated protective pads.

5. The automobile gearshift lever lock assembly as claimed in claim 1, wherein the core is provided on a front surface thereof with a heat-treated protective face plate.

6. The automobile gearshift lever lock assembly as claimed in claim 1, wherein the body of the lock has upper and lower surfaces in which positioning grooves are defined.

7. The automobile gearshift lever lock assembly as claimed in claim 1, wherein the body of the lock is protected, on opposite sides thereof, by heat-treated protection members.

8. The automobile gearshift lever lock assembly as claimed in claim 1, wherein the securing mechanism comprises a switching plate, a pin, and a securing plate.

9. The automobile gearshift lever lock assembly as claimed in claim 8, wherein the switching plate forms a slot and a positioning hole.

10. The automobile gearshift lever lock assembly as claimed in claim 8, wherein the securing plate is provided with a resilient element.

11. The automobile gearshift lever lock assembly as claimed in claim 8, wherein the securing plate forms a pin hole having a substantially triangular shape.

12. The automobile gearshift lever lock assembly as claimed in claim 1, wherein the body of the lock forms a plurality of raised positioning devices.

13. The automobile gearshift lever lock assembly as claimed in claim 1, wherein the coupling element forms an open channel.
